(19) United States
(12) Patent Application Publication
(10) Pub. No.: US 2012/0113780 A1
(43) Pub. Date: May 10, 2012

(54) METHOD AND APPARATUS FOR ACCESSING DATA FROM DISC WITH LINKING AREA

(75) Inventors: Chang-Long WU, Yi-Lan City (TW); Shu-Hung CHOU, Sanchong City (TW)

(73) Assignee: MEDIATEK INC., Hsin-Chu (TW)

(21) Appl. No.: 13/351,969

(22) Filed: Jan. 17, 2012

Related U.S. Application Data
(62) Division of application No. 12/277,379, filed on Nov. 25, 2008.

(51) Int. Cl. G11B 20/10

(52) U.S. Cl. 369/47.28; G9B/20.009

(57) ABSTRACT

An apparatus for accessing data from a disc with a linking area comprises a pick up head, a servo, a processing unit, a position predictor, and a control signal generator. The pick up head reads data from the disc and generates a read signal. The servo controls the pick up head. The processing unit processes the read signal and controls the servo according to a plurality of control signals. The position predictor tracks time position on the disc and generates position information. The control signal generator receives the position information and generates the control signals according to the position information.

This application is a divisional application of co-pending U.S. application Ser. No. 12/277,379, filed Nov. 25, 2008, the contents of which are incorporated herein by reference.

### BACKGROUND OF THE INVENTION

1. Field of the Invention

The invention relates to accessing data in a disc and, in particular, to a method and apparatus for accessing data in a disc with a linking area.

2. Description of the Related Art

FIGS. 1A and 1B are respectively schematic diagrams showing disc layout format of a disc without and with a linking area. Data recorded on a disc are typically frame-based. A frame sync pattern is arranged at a start point of a frame and used for synchronization thereof. In specifications of some discs, a linking area as shown in FIG. 1B is configured with some repeated patterns (data) to assist a phased locked loop (PLL) for calibrating and controlling recording power. Since data recorded on a disc with a linking area is not continuous, a start point of a data recording unit is predicted such that decoding can be performed.

FIGS. 2A to 2D are schematic diagrams of a disc layout format of a blue-ray disc (BD). FIG. 2A is a schematic diagram showing arrangement of a basic recording unit. In FIG. 2A, each recording unit comprises a run-in, a data area (ECC block), a run-out, and a guard. FIGS. 2B to 2D respectively illustrate data arrangement of a run-in field, a run-out field, and a guard field, which collectively form a linking area. A linking area comprises a region for automatic power calibration (APC) and a region for special or repeated signals. In an APC region, signals of any pattern, even invalid (or forbidden) signal pattern for data demodulation, can be used for automatic accessing power control. In a region for special or repeated signals, normal signal patterns for data modulation is used such that a PLL is assisted to recover a data bit clock, enabling data demodulation in a data area.

FIG. 3A is a schematic diagram showing layout of sequentially recording a data stream. In FIG. 3A, three recording units are taken for an example. Each data area in FIG. 3A starts with a run-in field and ends with run-out and guard fields. There is a run-in field between a blank area and the first data area. Also, several run-out and run-in fields are between the data areas, and a run-out field and a guard field are between the last data area and a blank area. In other words, there are linking areas between the blank areas and the data areas and the data areas themselves. As shown in FIGS. 3B and 3C, a start point (such as 345T APC area) of a recording unit (also a start point of a run-in field) is random in a specific range. The specific range is specified as an allowable range in proximity to an ideal start position. The start position is determined according to a pre-grooved wobble signal, containing physical position information, from the disc. In addition, an actual recorded data layout on a disc is not as ideal as that in FIG. 3A; usually, the actual recorded data layout is as shown in FIG. 3D. There may be shift or overwriting between recording units, as shown in FIG. 3D. In FIG. 3D, the second recording unit (such as 2nd ECC block) is recorded after first and third recording units. As a result, the second recording units is overwritten on the run-in and run-out fields of the first and third recording units. Thus, the ‘Guard’ area is overwritten by ‘Run-in’ area of 2nd ECC block, and the 2nd ECC block still keeps its own ‘Guard’ area.

In conventional methods of accessing data from a disc, when a region carrying such a physical address or the servo is not in a good condition, the physical address can not be detected correctly. As a result, prediction of a linking area has some errors, resulting in failure to find a right position of a start point of a data area, and thus decoding accuracy is degraded.

### BRIEF SUMMARY OF THE INVENTION

An embodiment of an apparatus for accessing data from a disc with a linking area comprises a pick up head, a servo, a processing unit, a position predictor, and a control signal generator. The pick up head reads data from the disc and generates a read signal. The servo controls the pick up head. The processing unit processes the read signal and controls the servo according to a plurality of control signals. The position predictor tracks time position on the disc and generates position information. The control signal generator receives the position information and generates the control signals according to the position information.

An embodiment of a method for accessing data from a disc with a linking area comprises: determining whether to reload a counter according to the demodulated data and priority check; generating predicted position according to the counter; finding a start point of a recording unit according to a range specified by the counter; and demodulating, decoding, or recording data on the recording unit.

Another embodiment of a method for accessing data from a disc with a linking area comprises reading data from the disc and generating a read signal; tracking time position on the disc according to the read signal and generating position information; generating control signals according to the position information; and controlling a processing unit according to the control signals.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A and 1B are respectively schematic diagrams showing disc layout format of a disc without and with a linking area;

FIG. 2A is a schematic diagram showing arrangement of a basic recording unit;

FIGS. 2B to 2D respectively illustrate data arrangement of a run-in field, a run-out field, and a guard field;

FIG. 3A is a schematic diagram showing layout of sequentially recording a data stream;

FIGS. 3B and 3C are schematic diagrams showing start position shift of a recording unit;

FIG. 3D is a schematic diagram showing actual recording results in a disc;

FIG. 4 is a block diagram of an apparatus for accessing data from a disc with a linking area according to an embodiment of the invention;

FIG. 5A is a block diagram of the position predictor 470 shown in FIG. 4;

FIG. 5B is a schematic diagram of reload of the counter according to decoded data address;

FIG. 6A is a schematic diagram of the control signal generator 480 in FIG. 4;

FIG. 6B is a timing diagram of the control signals generated by the control signal generator 480 in FIG. 4 of a BD disc;

FIG. 7A is a schematic diagram of an RF signal between a blank area and a data area;

FIG. 7B is a schematic diagram of an RF signal in an APC area between data areas;

FIG. 7C is a schematic diagram of an RF signal between a blank area and a data area according to an embodiment of the invention;

FIG. 7D is a schematic diagram of an RF signal in an APC area between data areas according to an embodiment of the invention; and

FIG. 8 is a flow chart of a method for accessing data from a disc with a linking area according to an embodiment of the invention.

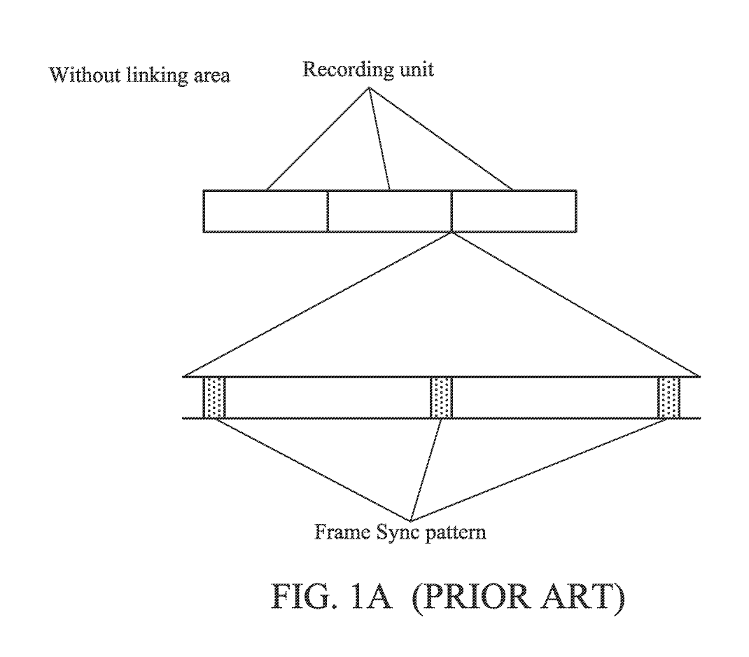

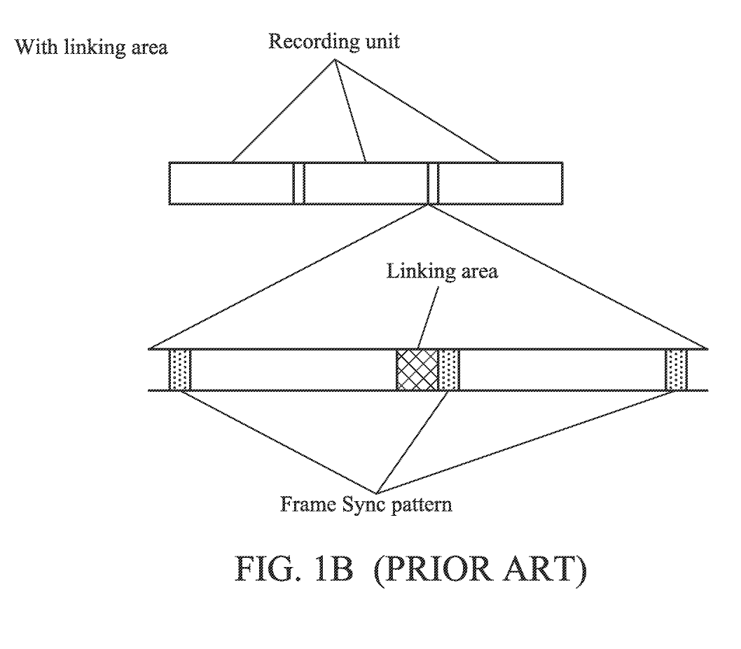

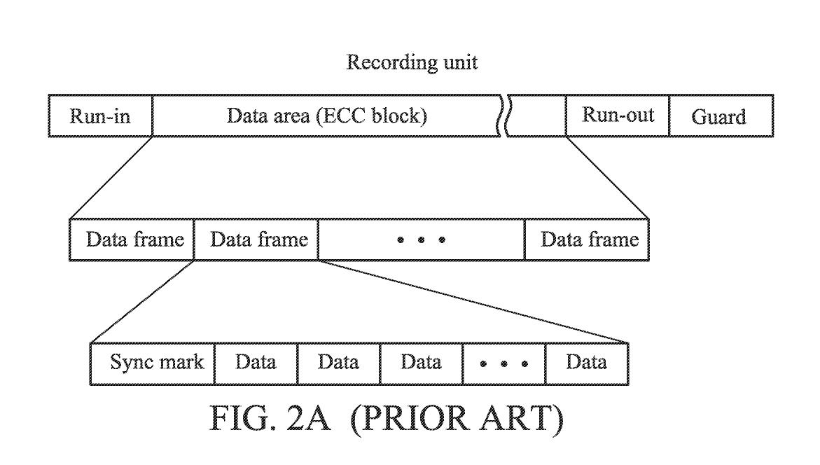

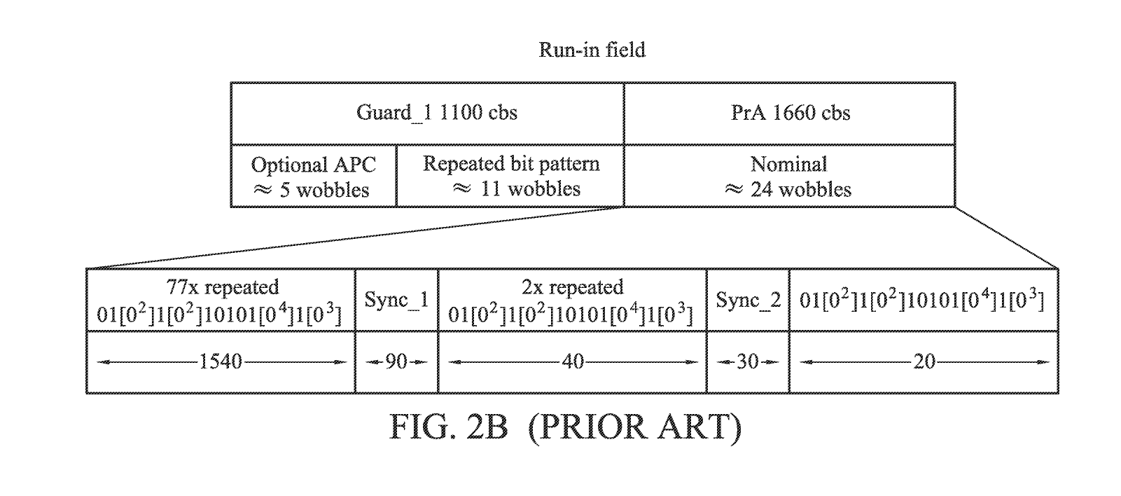

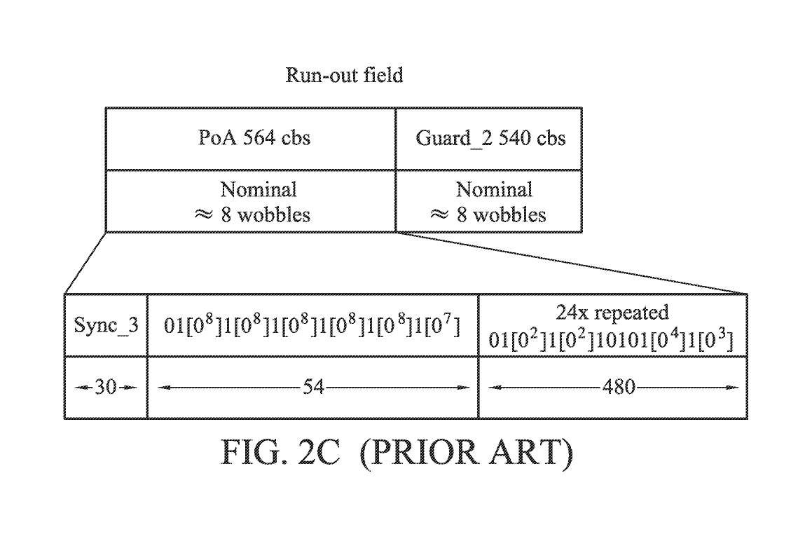

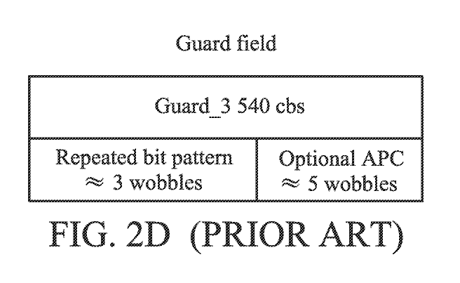

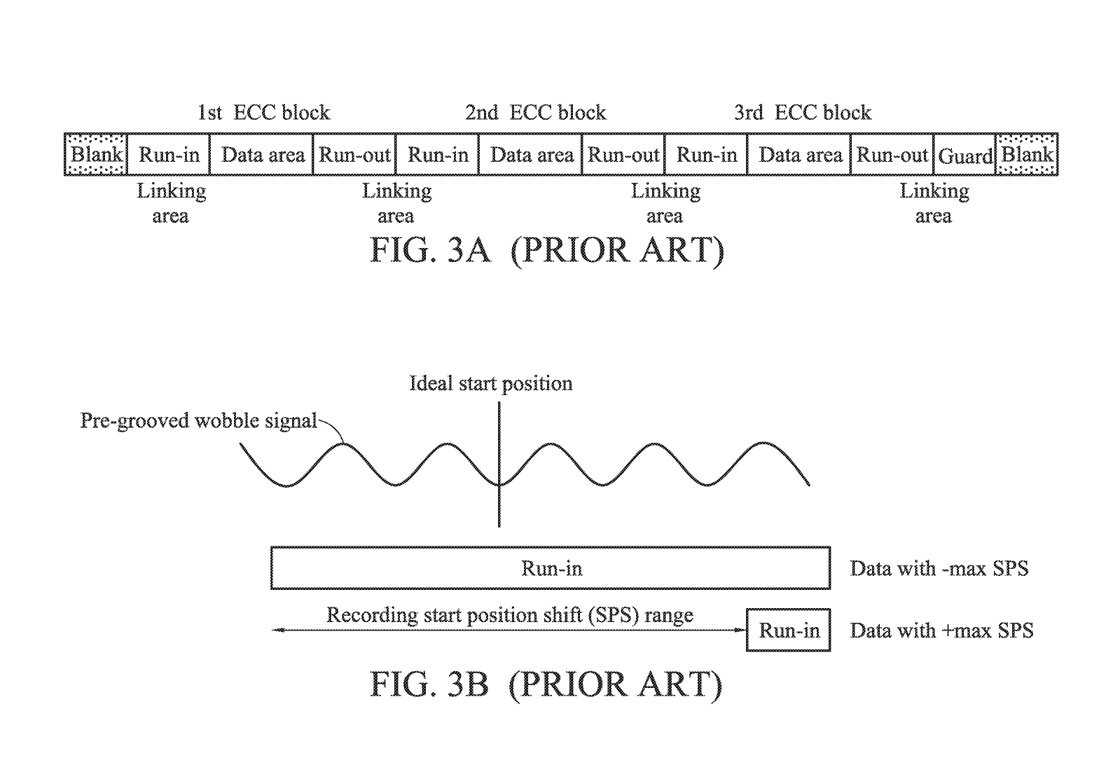

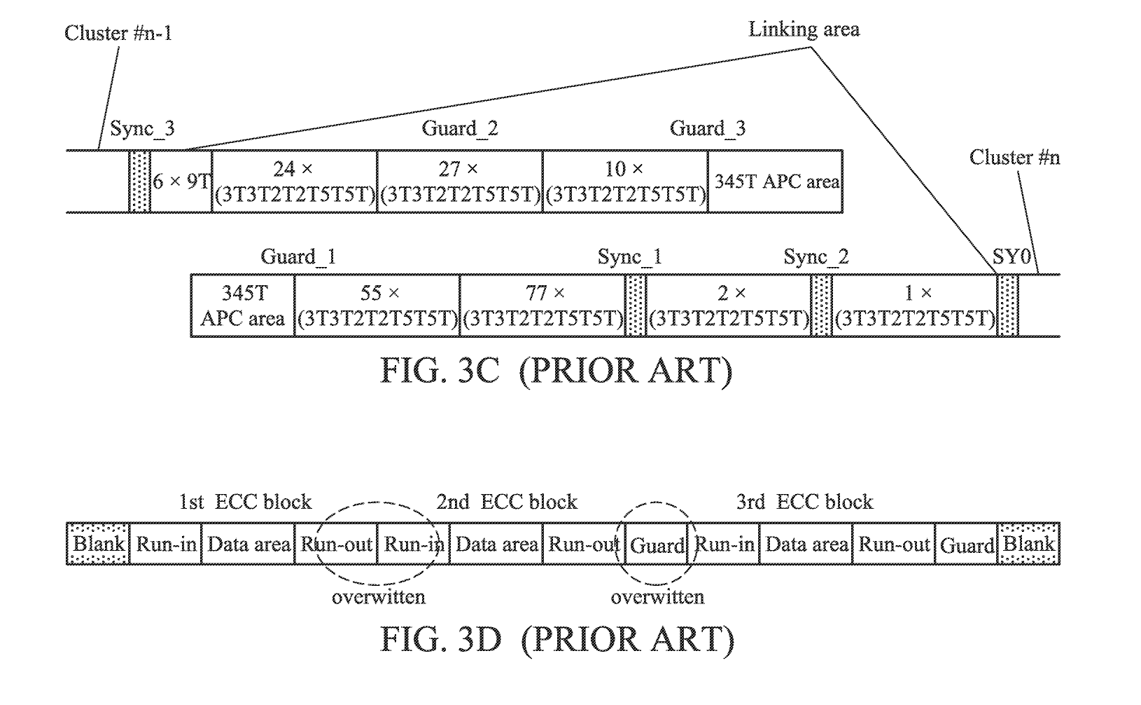

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

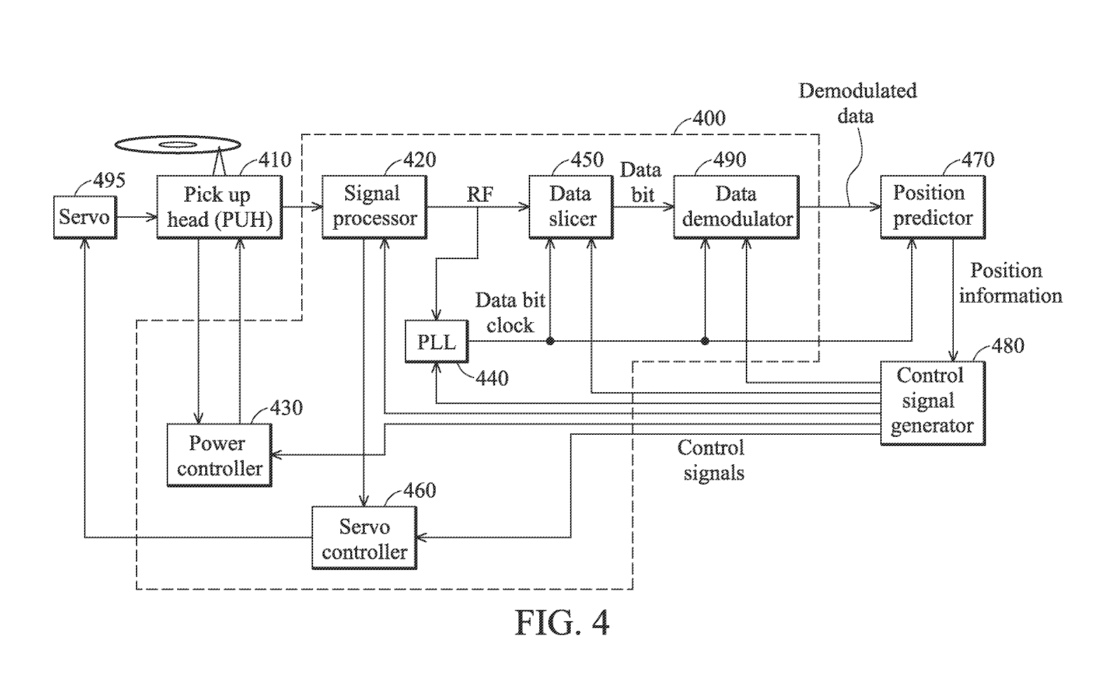

FIG. 4 is a block diagram of an apparatus for accessing data from a disc with a linking area according to an embodiment of the invention. The apparatus comprises a pick up head (PUH) 410, a signal processor 420, a power controller 430, a PLL 440, a data slicer 450, a servo controller 460, a position predictor 470, a control signal generator 480, a data demodulator 490, and a servo 495. In the embodiment, the signal processor 420, the power controller 430, the PLL 440, the data slicer 450, the servo controller 460, and the data demodulator 490 form a processing unit 400 which is controlled by control signals from the control signal generator 480. The pick up head (PUH) 410 is controlled by the servo 495 and arranged for reading data in the disc and generates a read signal according to the read data. The processing unit 400 then processes the read signal. Further, the processing unit 400 controls the servo 495.

In the processing unit 400, the signal processor 420 converts the read signal from a pick up head (PUH) 410 to a radio frequency (RF) signal. The power controller 430 controls power of the pick up head (PUH) 410 according to signals from the pick up head (PUH) 410. The PLL 440 recovers a data bit clock from the RF signal to be a reference clock for data demodulation, decoding, and positioning. In another example, PLL locks Data bit rather than RF. The data slicer 450 decides logic states of data according to voltage level of the RF signal for subsequent demodulation. The data demodulator 490 demodulates data bits from the data slicer 450 and generates demodulated data. The servo controller 460 controls focusing, tracking, rotation of the servo 495.

The position predictor 470 keeps tracking time position of a recording unit and updates the time position according to data demodulation and decoding results and further predicts time position of a linking area or any specific region. The time position is predicted by checking data address in the demodulation data from the disc, detecting a sync ID in the demodulation data, detecting specific patterns related to the linking area in the demodulation data, and/or checking physical address according to pre-grooved data from the disc. The control signal generator 480 compares position information from the position predictor 470 with a defined position (such as a predefined position profile) and generates the control signals for the signal processor 420, the power controller 430, the PLL 440, the data slicer 450, the servo controller 460, and the data demodulator 490 in the processing unit 400 according to the comparison result.

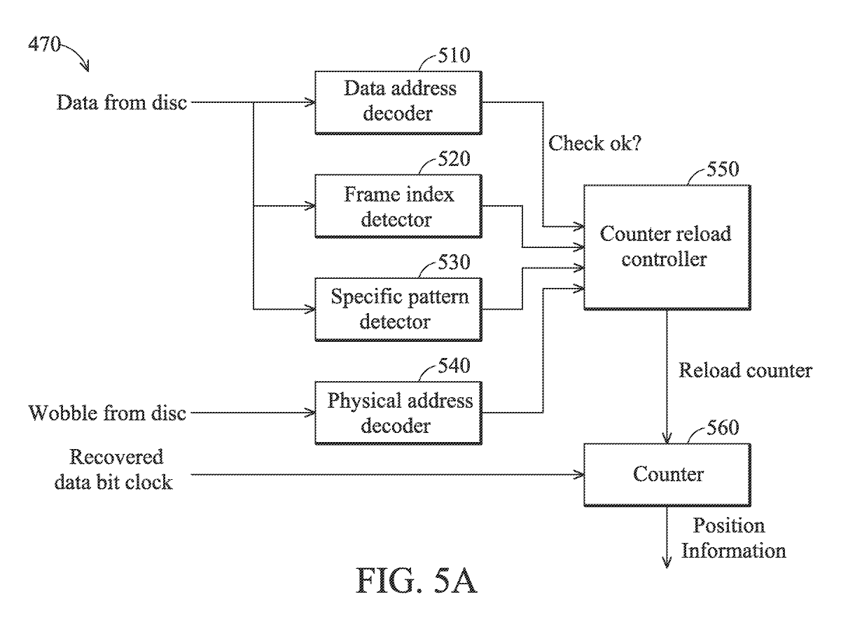

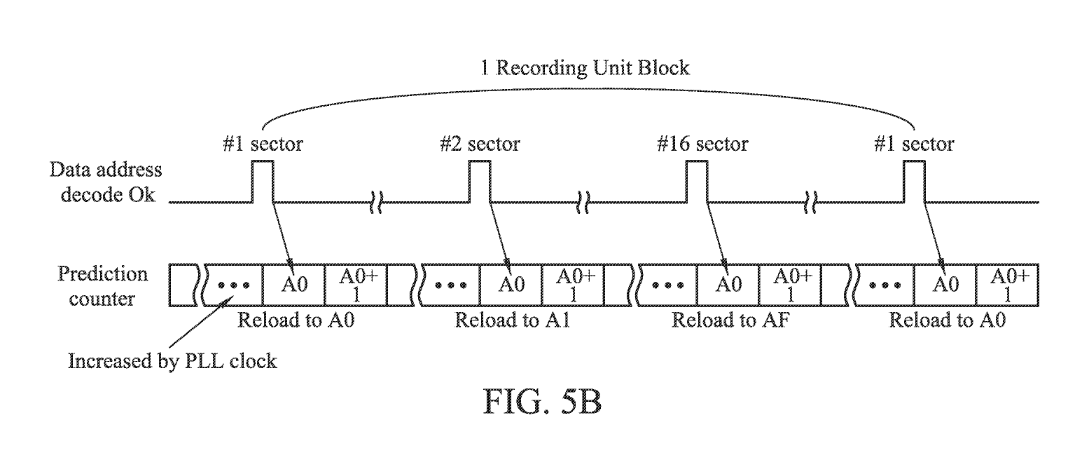

FIG. 5A is a block diagram of the position predictor 470 shown in FIG. 4. The position predictor 470 comprises a data address decoder 510, a frame index detector 520, a specific pattern detector 530, a physical address decoder 540, a counter reload controller 550, and a counter 560. The data address decoder 510 receives demodulated data from the disc, checks data address therein, and generates a first indicator signal representing correctness of the data address. The frame index detector 520 receives demodulated data from the disc, detects a sync ID therein to get a frame index, and generates a second indicator signal representing correctness of the frame index. The specific pattern detector 530 receives demodulated data from the disc, detects specific patterns related to the linking area, and generates a third indicator signal representing whether any of the specific patterns is found in the demodulated data. The physical address decoder 540 receives pre-grooved data from the disc, checks physical address, and generates a fourth indicator signal representing correctness of the physical address. The counter reload controller 550 determines whether and when to reload the counter 560 according to the first, second, third, and fourth indicator signals. Wherein reloading means issuing a new value for the counter 560 to start counting, and value stored in the counter 560 is updated thereby. The counter 560 receives the recovered data bit clock and keeps tracking time position of current recording unit (ECC block for DVD and cluster for BD). The counter 560 keeps counting according to the recovered data bit clock and can be reloaded by the counter reload controller 550. It is noted that priority of the first, second, third, and fourth indicator signals may also be a factor which determines reload of the counter 560. For example, decoded data address may be more accurate than detected specific patterns. Accordingly, when a decoded data address is available, then reload of the counter 560 according to the detected specific patterns is not required.

FIG. 5B is a schematic diagram of reload of the counter according to decoded data address. When the data address is decoded, an ideal counter value A0, A1, . . . , or AF is reloaded into the counter 560. Take BD for example. There are 16 sectors in a cluster and each sector on the disc has a unique address. Accordingly, if the data address is successfully decoded, time position of current position can be found and the counter 560 can be reloaded accordingly thereto. Thereafter, the counter 560 keeps counting according to the recovered data bit clock from the PLL. When the PLL is in a lock state, an actual time position can be obtained. In addition, in a case of reload of the counter according to physical address, there are three absolute addresses in pre-groove (ADIP) word units in a BD disc. Correctness of the decoded ADIP address can also be used to reload the counter 560.

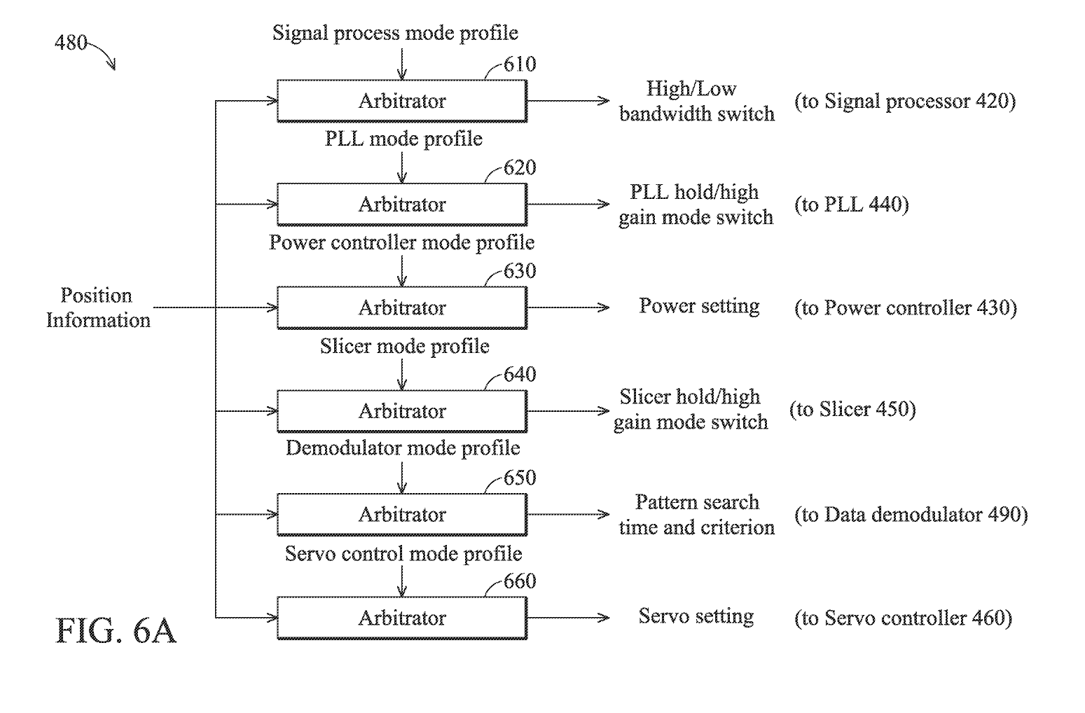

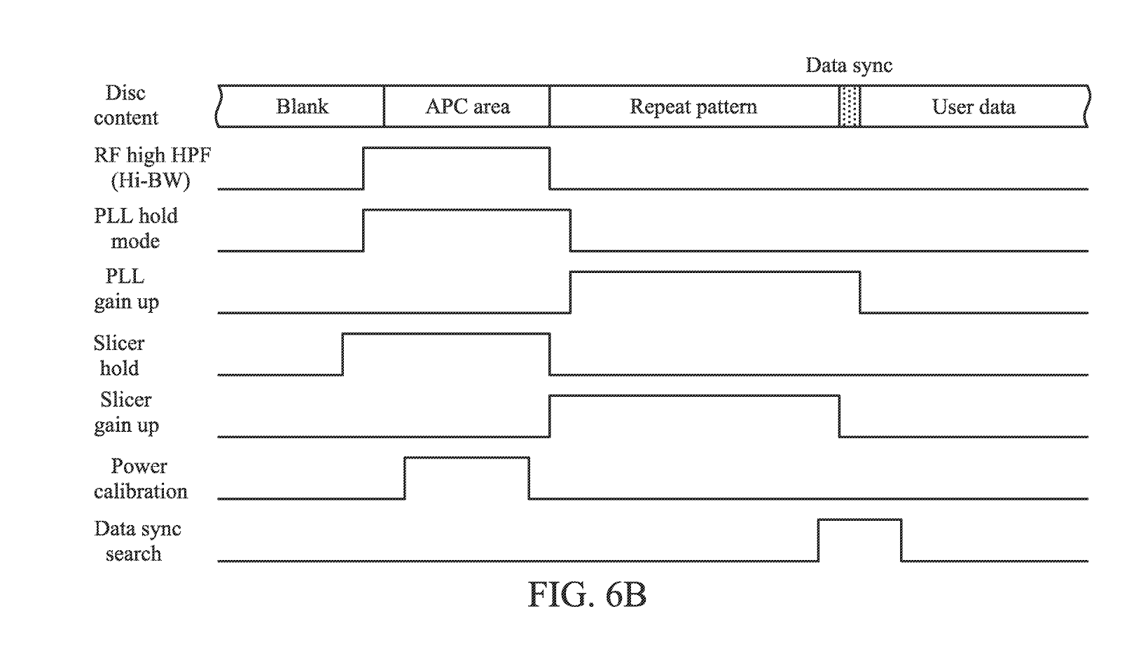

FIG. 6A is a schematic diagram of the control signal generator 480 in FIG. 4. The control signal generator 480 comprises arbitrators 610, 620, . . . , and 660. The arbitrator 610 generates a first control signal for switching high pass or high/low bandwidth setting of the signal processor 420 at a specific location of a recording unit by comparing position information from a position predictor with a position defined in a signal process mode profile. The arbitrator 620 generates a second control signal for switching hold/high gain mode of the phase locked loop (PLL) 440 by comparing position information from the position predictor with a position defined in a PLL mode profile. The arbitrator 630 generates a third control signal for power setting of the power controller 430 by comparing position information from the position predictor with a position defined in a power controller mode profile. The arbitrator 640 generates a fourth control signal for switching hold/high gain mode of the data slicer 450 by comparing position information from the position predictor with a position defined in a slicer mode profile. The arbitrator 650 generates a fifth control signal for adjusting pattern search time and criterion of the data demodulator 490 by comparing position information from the position predictor with a position defined in a demodulator mode profile. The arbitrator 660 generates a sixth control signal for servo setting of the servo controller 460 by comparing position information from the position predictor with a position defined in a servo control mode profile.

FIG. 6B is a timing diagram of the control signals generated by the control signal generator 480 in FIG. 4 of a BD disc. When the current position migrates from a blank area to a user data area, the first control signal sets the signal processor to a high pass and a high bandwidth mode such that RF signal level converges to a normal level quickly. In an APC area, the second and fourth control signals hold the PLL and the slicer such that signal convergence is not influenced by the signal in the APC area, which does not meet modulation rules. In addition, in the APC area, power calibration of the power controller is enabled such that best power settings can be obtained. In the repeated pattern area, the PLL and the slicer is set as a high gain mode to expedite convergence such that subsequent data sync and user data can be correctly detected and demodulated. In addition, a first data sync is searched around a predetermined position of a recording unit such that start position shift can be covered. It means the searching range of the first data sync is restricted within the pulse of the signal ‘data sync search’ shown in FIG. 6B.

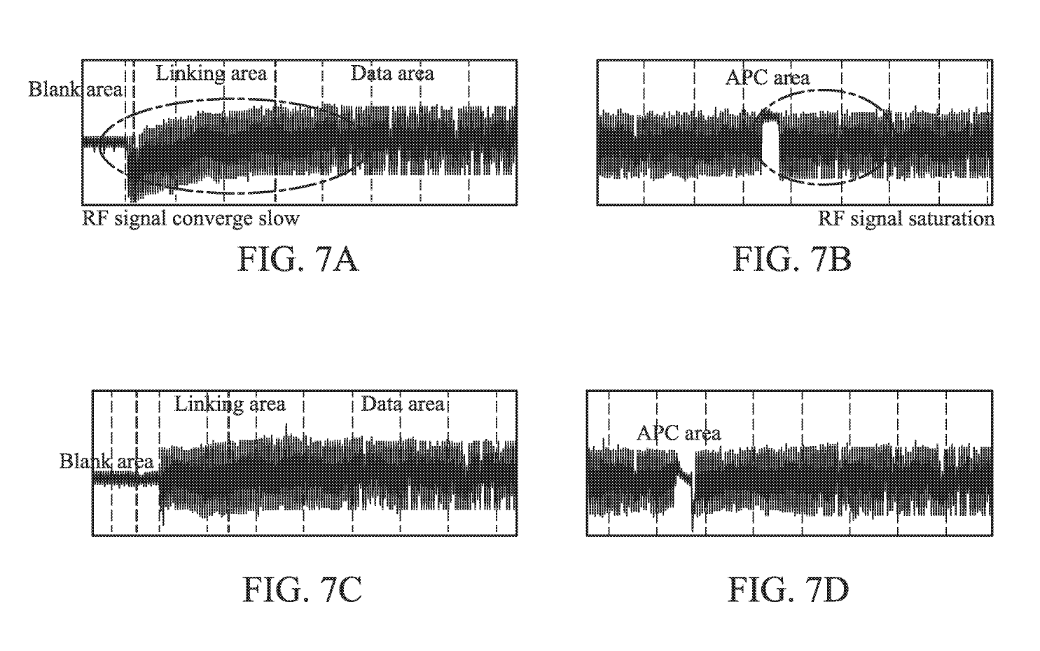

In some conventional methods of accessing data from a disc, since there is difference in reflectivity between a blank area and a data area as shown in FIG. 7A, a significant difference in RF signal level results therebetween. It typically takes an extended period of time for the RF signal to converge to a normal level. Moreover, since the RF signal level between the data areas keeps high as shown in FIG. 7B, thus the RF signal level is easy to be saturated and the real value of the signal is hard to be detected. The RF signal typically saturates at the beginning of the second data area and takes time to converge to a normal level. Additionally, according to FIG. 7A, the RF signal convergence is slow, resulting in negative impact in decoding accuracy.

FIG. 7C is a schematic diagram of an RF signal between a blank area and a data area according to an embodiment of the invention, and FIG. 7D is a schematic diagram of an RF signal in an APC area between data areas according to an embodiment of the invention. Compared with the conventional methods, FIGS. 7B and 7C are respectively schematic diagrams of an RF signal in an APC area between data areas and the data area themselves according to an embodiment of the invention. Since high pass or high/low bandwidth of the signal processor can be switched by the control signal generated by the control signal generator in the embodiments of the invention; RF signal convergence is expedited, as shown in FIG. 7C.

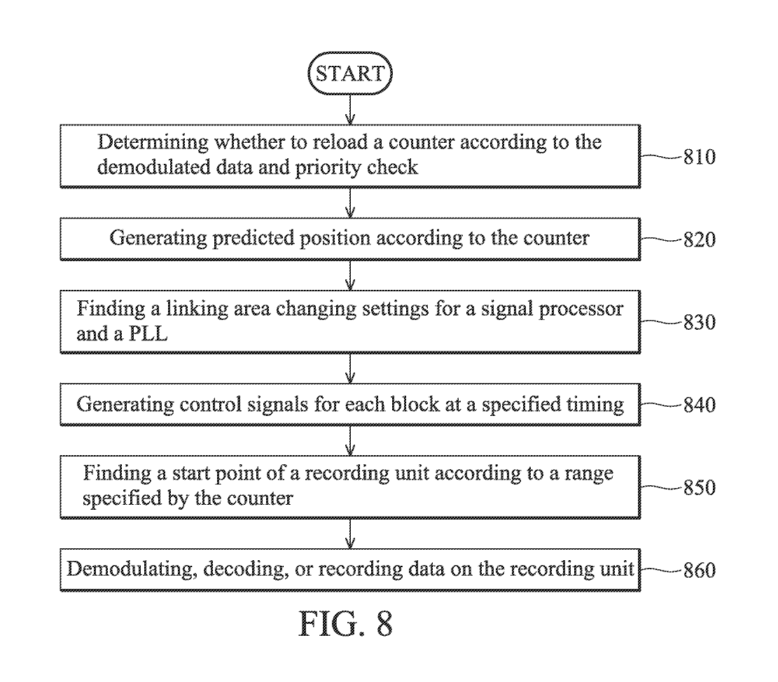

FIG. 8 is a flow chart of a method for accessing data from a disc with a linking area according to an embodiment of the invention. The method comprises determining whether to reload a counter according to the demodulated data and priority check of the indicator signals (step 810), generating predicted position according to the counter (step 820), finding a linking area changing settings for a signal processor and a PLL (step 830), generating control signals for each block at a specified timing (step 840), finding a start point of a recording unit according to a range specified by the counter (step 850), and demodulating, decoding, or recording data on the recording unit (step 860).

Embodiments of the invention provide a method and an apparatus for accessing data from a disc with a linking area. According to embodiments of the invention, a counter is automatically reloaded according to decoding of data address, accuracy of sync pattern, decoding of physical address or detection of repeated patterns in a linking area such that prediction of a linking area is more accurate. In addition, prediction of position is utilized to generate control signals for an RF signal processor, a PLL, a slicer, and a servo at specific timings such that decoding accuracy in data areas is improved.

While the invention has been described by way of example and in terms of preferred embodiment, it is to be understood that the invention is not limited thereto. Alternatively, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An apparatus for accessing data from a disc with a linking area, comprising:
a pick up head for reading data from the disc and generating a read signal;
a servo for controlling the pick up head;
a processing unit for processing the read signal and controlling the servo according to a plurality of control signals;
a position predictor for tracking time position on the disc and generating position information; and
a control signal generator for receiving the position information and generating the control signals according to the position information.

2. The apparatus as claimed in claim 1, wherein the processing unit comprises a signal processor for converting the read signal from the pick up head to a radio frequency (RF) signal, and the control signal generator generates a first control signal for switching high pass or high/low bandwidth setting of the signal processor at a specific location of a recording unit by comparing the position information with a position defined in a signal process mode profile.

3. The apparatus as claimed in claim 1, wherein the processing unit comprises a phase locked loop (PLL), and the control signal generator generates a second control signal for switching hold/high gain mode of the PLL by comparing the position information with a position defined in a PLL mode profile.

4. The apparatus as claimed in claim 1, wherein the processing unit comprises a power controller, and the control signal generator generates a third control signal for power setting of the power controller by comparing the position information with a position defined in a power controller mode profile.

5. The apparatus as claimed in claim 1, wherein the processing unit comprises a slicer, and the control signal generator generates a fourth control signal for switching hold/high gain mode of the slicer by comparing position information with a position defined in a slicer mode profile.

6. The apparatus as claimed in claim 1, wherein the processing unit comprises a demodulator, and the control signal generator generates a fifth control signal for adjusting pattern search time and criterion of the demodulator by comparing position information with a position defined in a demodulator mode profile.

7. The apparatus as claimed in claim 1, wherein the processing unit comprises a servo controller, and the control signal generator further generates a sixth control signal for servo setting of the servo controller by comparing position information with a position defined in a servo control mode profile.

8. The apparatus as claimed in claim 1, wherein the position predictor comprises a data address decoder receiving demodulated data and a counter reload controller coupled to the data address decoder and controlling whether to reload a counter.

9. The apparatus as claimed in claim 1, wherein the position predictor comprises a data address decoder checking data address and generating a first indicator signal representing correctness of the data address.

10. The apparatus as claimed in claim 1, wherein the position predictor comprises a frame index detector detecting a sync ID to get a frame index and generating a second indicator signal representing correctness of the frame index.

11. The apparatus as claimed in claim 1, wherein the position predictor comprises a specific pattern detector detecting specific patterns of the linking area and generating a third indicator signal representing whether any of the specific patterns is found in the demodulated data.

12. The apparatus as claimed in claim 1, wherein the position predictor comprises a physical address decoder checking physical address and generating a fourth indicator signal representing correctness of the physical address.
